(19) United States
(12) Patent Application Publication
(10) Pub. No.: US 2026/0343672 A1
(43) Pub. Date: Oct. 29, 2026

(54) MULTICAST BROADCAST SERVICES SESSION STATUS REPORTING

(71) Applicant: QUALCOMM Incorporated, San Diego, CA (US)

(72) Inventors: Amer CATOVIC, San Diego, CA (US); Miguel GRIOT, La Jolla, CA (US); Haris ZISIMOPOULOS, London (GB); Prasad Reddy KADIRI, San Diego, CA (US)

(21) Appl. No.: 19/099,667

(22) PCT Filed: Sep. 18, 2023
(86) PCT No.: PCT/US2023/074458

§ 371 Date: Jan. 29, 2025

(30) Foreign Application Priority Data
Oct. 7, 2022 (GR) 20220100825

(51) Int. Cl. H04W 76/30; H04W 4/06; H04W 60/04; H04W 76/20

(52) U.S. Cl. CPC H04W 76/30; H04W 4/06; H04W 60/04; H04W 76/20

(57) ABSTRACT

Various aspects of the present disclosure generally relate to wireless communication. In some aspects, a user equipment (UE) may leave a multicast broadcast services (MBS) session without leaving a packet data unit (PDU) session associated with the MBS session. The UE may transmit a signaling message after leaving the MBS session. The signaling message may include an information element (IE) comprising an MBS session status indication associated with the MBS session. Numerous other aspects are described.

### CROSS-REFERENCE TO RELATED APPLICATION

This Patent Application claims priority to Greek Patent Application No. 20220100825, filed on Oct. 7, 2022, entitled “MULTICAST BROADCAST SERVICES SESSION STATUS REPORTING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for multicast broadcast services (MBS) session status reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a user equipment (UE). The method may include leaving a multicast broadcast services (MBS) session without leaving a packet data unit (PDU) session associated with the MBS session. The method may include transmitting a signaling message after leaving the MBS session, the signaling message including an information element (IE) comprising an MBS session status indication associated with the MBS session.

Some aspects described herein relate to a method of wireless communication performed by an apparatus of a UE. The method may include leaving an MBS session without leaving a PDU session associated with the MBS session. The method may include transmitting, for reception by a radio access network (RAN) node and based on leaving the MBS session, a signaling message including an indication that the UE has left the MBS session.

Some aspects described herein relate to a method performed by an apparatus of a core network node. The method may include receiving a non-access stratum (NAS) message including an MBS session status IE, where the MBS session status information IE includes an MBS session identifier corresponding to an MBS session of a UE and an MBS session status indication indicating a status of the MBS session. The method may include identifying a session management function (SMF) node based at least in part on an MBS context associated with the UE and the MBS session identifier. The method may include forwarding the MBS session status indication to the SMF node.

Some aspects described herein relate to a method performed by an apparatus of a RAN node. The method may include receiving a signaling message including an indication that a UE has left a MBS session. The method may include removing the UE from the MBS session based at least in part on the indication that the UE has left the MBS session.

Some aspects described herein relate to a method performed by an apparatus of a core network node. The method may include receiving an indication to release a MBS session of a UE, the indication including at least one of an MBS session status indication associated with the MBS session, the MBS session status indication indicating that the MBS session is inactive, or an indication that the UE has been removed from the MBS session. The method may include releasing the MBS session based at least in part on the indication to release the MBS session.

Some aspects described herein relate to a UE for wireless communication. The user equipment may include a memory and one or more processors coupled to the memory. The one or more processors may be configured to leave a MBS session without leaving a PDU session associated with the MBS session. The one or more processors may be configured to transmit a signaling message after leaving the MBS session, the signaling message including an IE comprising an MBS session status indication associated with the MBS session.

Some aspects described herein relate to a UE for wireless communication. The user equipment may include a memory and one or more processors coupled to the memory. The one or more processors may be configured to leave a MBS session without leaving a PDU session associated with the MBS session. The one or more processors may be configured to transmit, for reception by a RAN node and based on leaving the MBS session, a signaling message including an indication that the UE has left the MBS session.

Some aspects described herein relate to a core network node. The core network node may include a memory and one or more processors coupled to the memory. The one or more processors may be configured to receive a NAS message including a MBS session status IE. The one or more processors may be configured to identify an SMF node based at least in part on an MBS context associated with the UE and the MBS session identifier. The one or more processors may be configured to forward the MBS session status indication to the SMF node.

Some aspects described herein relate to a RAN node. The RAN node may include a memory and one or more processors coupled to the memory. The one or more processors may be configured to receive a signaling message including an indication that a UE has left a MBS session. The one or more processors may be configured to remove the UE from the MBS session based at least in part on the indication that the UE has left the MBS session.

Some aspects described herein relate to a core network node. The core network node may include a memory and one or more processors coupled to the memory. The one or more processors may be configured to receive an indication to release a MBS session of a UE, the indication including at least one of an MBS session status indication associated with the MBS session, the MBS session status indication indicating that the MBS session is inactive, or an indication that the UE has been removed from the MBS session. The one or more processors may be configured to release the MBS session based at least in part on the indication to release the MBS session.

Some aspects described herein relate to a non-transitory computer-readable medium that stores a set of instructions for wireless communication that, when executed by one or more processors of an apparatus, may cause the one or more processors to leave a MBS session without leaving a PDU session associated with the MBS session. The set of instructions, when executed by the one or more processors may cause the apparatus to transmit a signaling message after leaving the MBS session, the signaling message including an IE comprising an MBS session status indication associated with the MBS session.

Some aspects described herein relate to a non-transitory computer-readable medium that stores a set of instructions for wireless communication that, when executed by one or more processors of an apparatus, may cause the apparatus to leave a MBS session without leaving a PDU session associated with the MBS session. The set of instructions, when executed by the one or more processors may cause the apparatus to transmit, for reception by a RAN node and based on leaving the MBS session, a signaling message including an indication that the UE has left the MBS session.

Some aspects described herein relate to a non-transitory computer-readable medium that stores a set of instructions by a one or more instructions that, when executed by one or more processors of an apparatus, may cause the apparatus to receive a NAS message including a MBS session status IE. The set of instructions, when executed by the one or more processors, may cause the apparatus to identify an SMF node based at least in part on an MBS context associated with the UE and the MBS session identifier. The set of instructions, when executed by the one or more processors, may cause the apparatus to forward the MBS session status indication to the SMF node.

Some aspects described herein relate to a non-transitory computer-readable medium that stores a set of instructions that, when executed by one or more processors of an apparatus, may cause the apparatus to receive a signaling message including an indication that a UE has left a MBS session. The set of instructions, when executed by the one or more processors, may cause the apparatus to remove the UE from the MBS session based at least in part on the indication that the UE has left the MBS session.

Some aspects described herein relate to a non-transitory computer-readable medium that stores a set of instructions by a one or more instructions that, when executed by one or more processors of an apparatus, may cause the apparatus to receive an indication to release a MBS session of a UE, the indication including at least one of an MBS session status indication associated with the MBS session, the MBS session status indication indicating that the MBS session is inactive, or an indication that the UE has been removed from the MBS session. The set of instructions, when executed by the one or more processors, may cause the apparatus to release the MBS session based at least in part on the indication to release the MBS session.

Some aspects described herein relate to an apparatus for wireless communication. The apparatus may include means for leaving a MBS session without leaving a PDU session associated with the MBS session. The apparatus may include means for transmitting a signaling message after leaving the MBS session, the signaling message including an IE comprising an MBS session status indication associated with the MBS session.

Some aspects described herein relate to an apparatus for wireless communication. The apparatus may include means for leaving a MBS session without leaving a PDU session associated with the MBS session. The apparatus may include means for transmitting, for reception by a RAN node and based on leaving the MBS session, a signaling message including an indication that the UE has left the MBS session.

Some aspects described herein relate to an apparatus. The apparatus may include means for receiving a NAS message including a MBS session status IE, where the MBS session status information IE includes an MBS session identifier corresponding to an MBS session of a UE and an MBS session status indication indicating a status of the MBS session. The apparatus may include means for identifying an SMF node based at least in part on an MBS context associated with the UE and the MBS session identifier. The apparatus may include means for forwarding the MBS session status indication to the SMF node.

Some aspects described herein relate to an apparatus. The apparatus may include means for receiving a signaling message including an indication that a UE has left a MBS session. The apparatus may include means for removing the UE from the MBS session based at least in part on the indication that the UE has left the MBS session.

Some aspects described herein relate to an apparatus. The apparatus may include means for receiving an indication to release a MBS session of a UE, the indication including at least one of an MBS session status indication associated with the MBS session, the MBS session status indication indicating that the MBS session is inactive, or an indication that the UE has been removed from the MBS session. The apparatus may include means for releasing the MBS session based at least in part on the indication to release the MBS session.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram of an example of a core network, in accordance with the present disclosure.

FIG. 5 is a diagram of example components of a device associated with the core network, in accordance with the present disclosure.

FIGS. 6A and 6B are diagrams illustrating examples associated with MBS session status reporting, in accordance with the present disclosure.

FIG. 7 is a diagram illustrating an example process performed, for example, by a UE, in accordance with the present disclosure.

FIG. 8 is a diagram illustrating an example process performed, for example, by a UE, in accordance with the present disclosure.

FIG. 9 is a diagram illustrating an example process performed, for example, by a core network node, in accordance with the present disclosure.

FIG. 10 is a diagram illustrating an example process performed, for example, by a RAN node, in accordance with the present disclosure.

FIG. 11 is a diagram illustrating an example process performed, for example, by a core network node, in accordance with the present disclosure.

FIGS. 12-15 are diagrams of example apparatuses, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system. While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

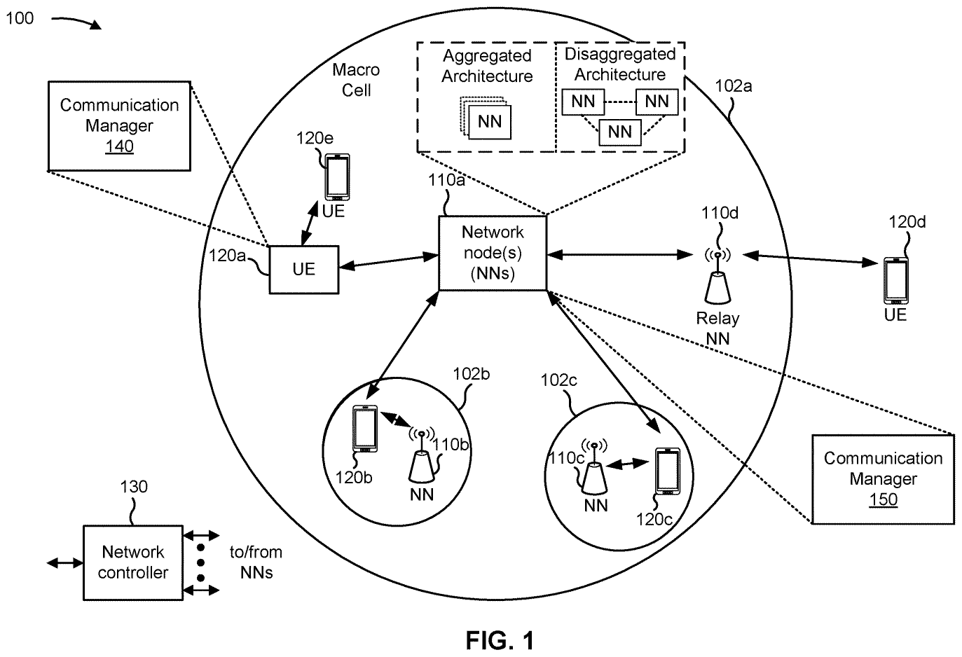

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network node, or may include a CU or a core network node.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may leave a multicast broadcast services (MBS) session without leaving a packet data unit (PDU) session associated with the MBS session; and transmit a signaling message after leaving the MBS session, the signaling message including an information element (IE) comprising an MBS session status indication associated with the MBS session. Additionally, or alternatively, as described in more detail elsewhere herein, the communication manager 140 may leave an MBS session without leaving a PDU session associated with the MBS session; and transmit, for reception by a RAN node (e.g., a network node 110) and based on leaving the MBS session, a signaling message including an indication that the UE 120 has left the MBS session. Additionally, or alternatively, the communication manager 140 may perform one or more other operations described herein.

In some aspects, a RAN node, such as a network node 110, may include a communication manager 150. As described in more detail elsewhere herein, the communication manager 150 may receive a signaling message including an indication that a UE 120 has left an MBS session; and remove the UE 120 from the MBS session based at least in part on the indication that the UE 120 has left the MBS session. Additionally, or alternatively, the communication manager 150 may perform one or more other operations described herein.

As indicated above, FIG. 1 is provided as an example. Other examples may differ from what is described with regard to FIG. 1.

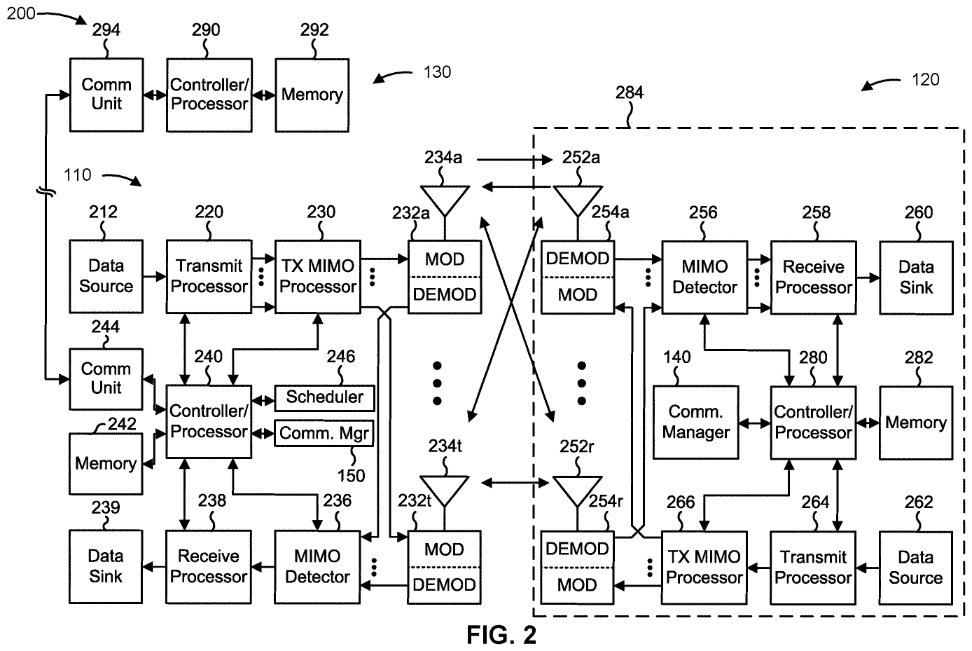

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

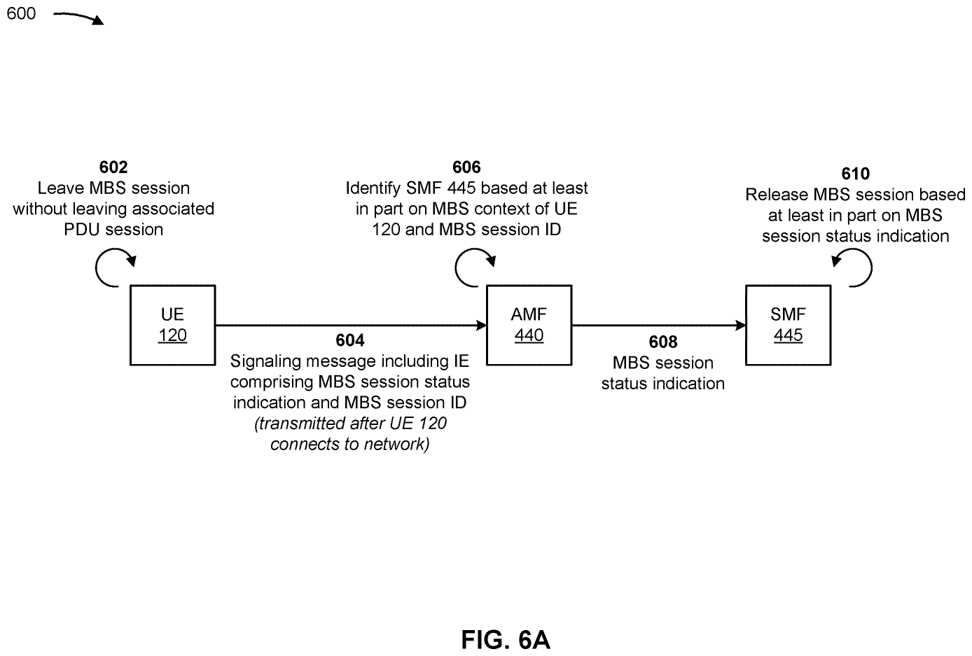

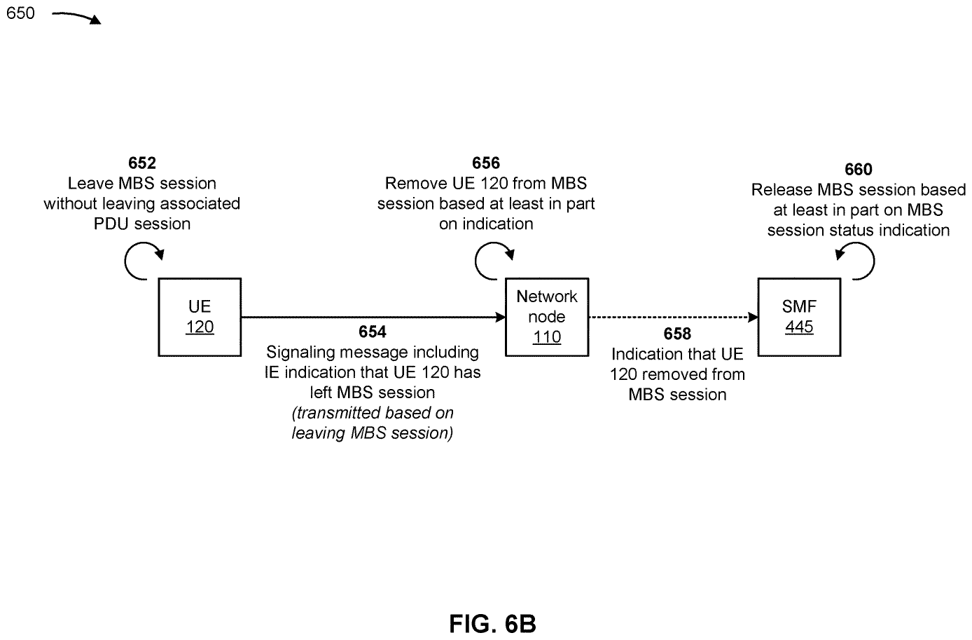

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-15).

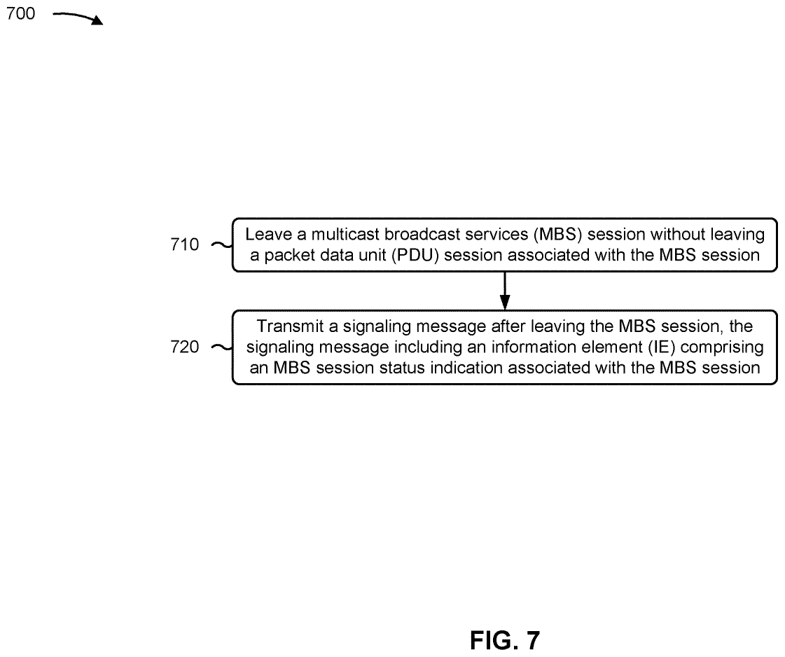

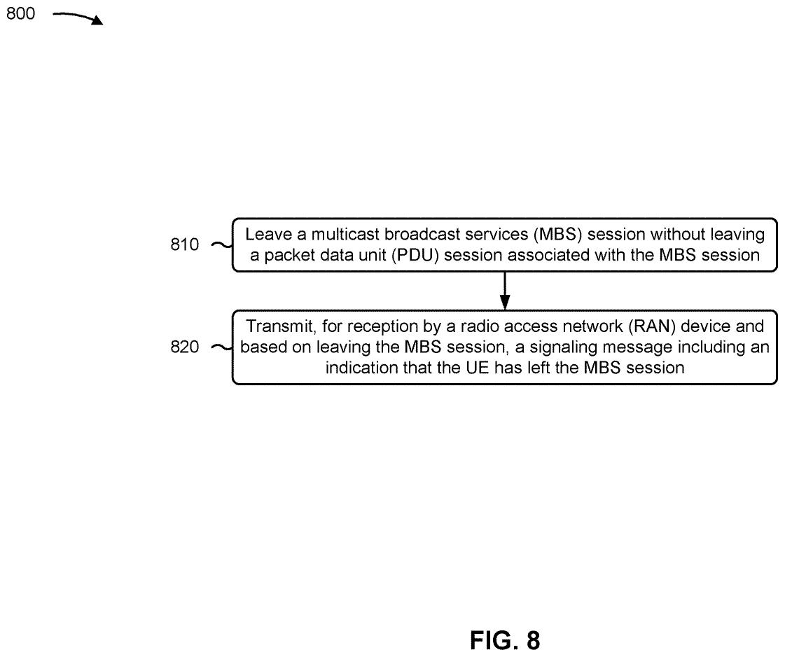

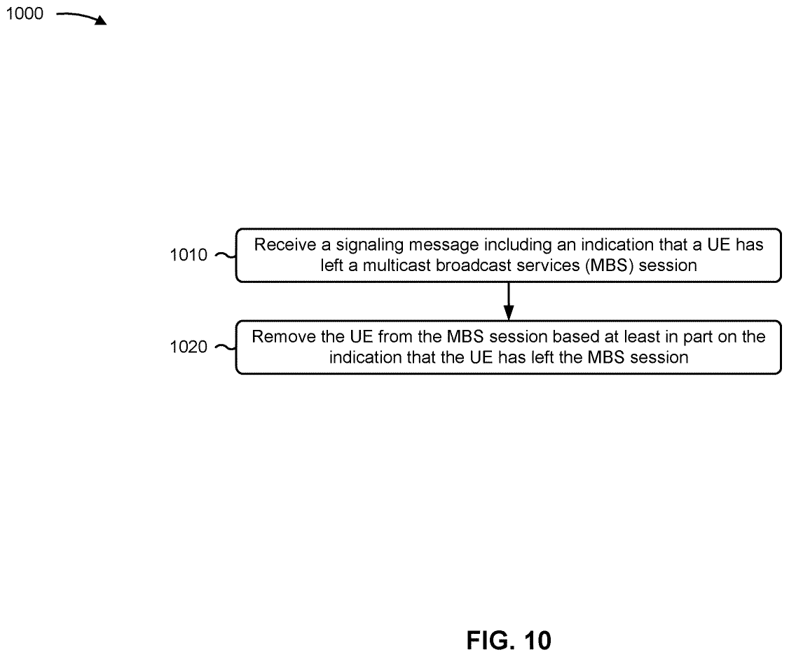

The controller/processor 240 of the network node 110, the controller/processor 280 of the UE 120, and/or any other component(s) of FIG. 2 may perform one or more techniques associated with MBS session status reporting, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for leaving an MBS session without leaving a PDU session associated with the MBS session; and/or means for transmitting a signaling message after leaving the MBS session, the signaling message including an IE comprising an MBS session status indication associated with the MBS session. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for leaving an MBS session without leaving a PDU session associated with the MBS session; and/or means for transmitting, for reception by a RAN node (e.g., a network node 110) and based on leaving the MBS session, a signaling message including an indication that the UE 120 has left the MBS session. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a RAN node (e.g., a network node 110) includes means for receiving a signaling message including an indication that a UE 120 has left an MBS session; and/or means for removing the UE 120 from the MBS session based at least in part on the indication that the UE 120 has left the MBS session. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

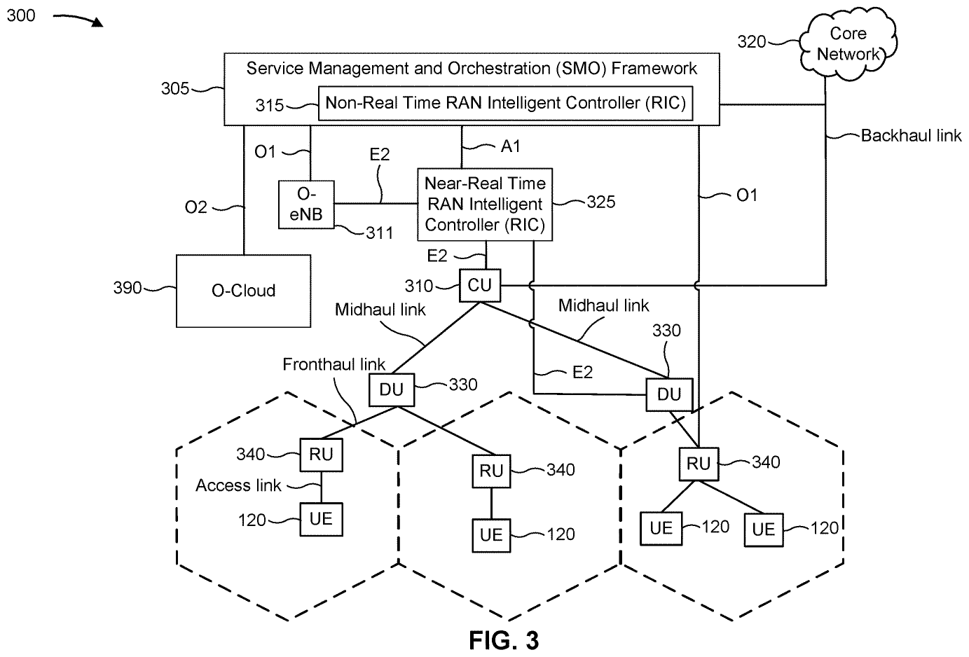

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units. In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture. The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective Ol interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

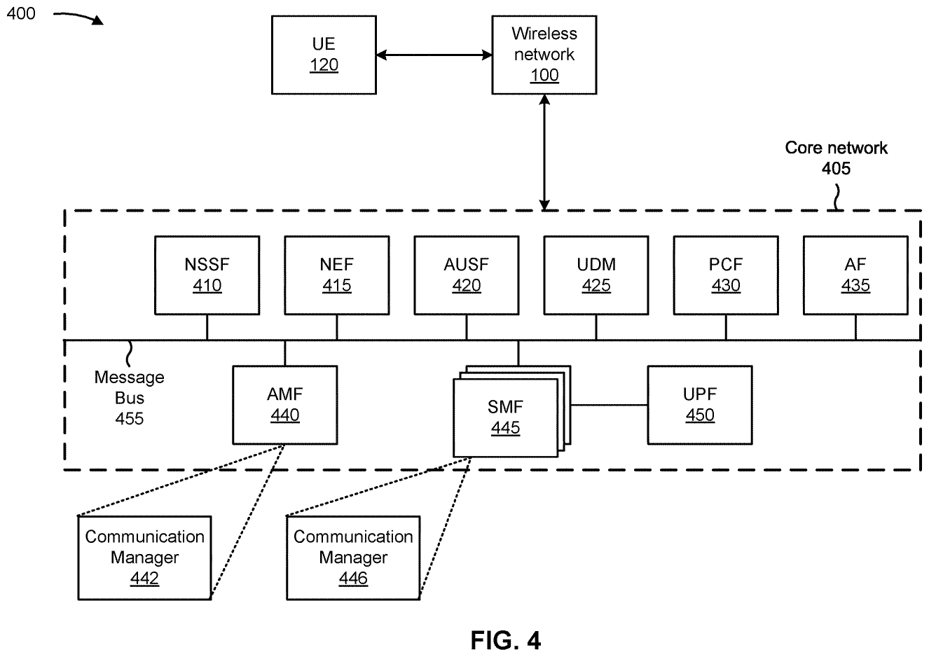

FIG. 4 is a diagram of an example 400 of a core network 405, in accordance with the present disclosure. As shown in FIG. 4, example 400 may include a UE 120, a wireless network 100, and a core network 405. Devices and/or networks of example 400 may interconnect via wired connections, wireless connections, or a combination thereof.

The wireless network 100 may support, for example, a cellular radio access technology (RAT). The wireless network 100 may include one or more network nodes, such as base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network nodes that can support wireless communication for the UE 120. The wireless network 100 (also referred to as a radio access network (RAN)) may transfer traffic between the UE 120 (e.g., using a cellular RAT), one or more network nodes (e.g., using a wireless interface or a backhaul interface, such as a wired backhaul interface), and/or the core network 405. The wireless network 100 may provide one or more cells that cover geographic areas.

In some aspects, the wireless network 100 may perform scheduling and/or resource management for the UE 120 covered by the wireless network 100 (e.g., the UE 120 covered by a cell provided by the wireless network 100). In some aspects, the wireless network 100 may be controlled or coordinated by a network controller (e.g., network controller 130 of FIG. 1), which may perform load balancing and/or network-level configuration, among other examples. As described above in connection with FIG. 1, the network controller may communicate with the wireless network 100 via a wireless or wireline backhaul. In some aspects, the wireless network 100 may include a network controller, a self-organizing network (SON) module or component, or a similar module or component. Accordingly, the wireless network 100 may perform network control, scheduling, and/or network management functions (e.g., for uplink, downlink, and/or sidelink communications of the UE 120 covered by the wireless network 100).

The core network 405 illustrated in FIG. 4 includes an example functional architecture in which systems and/or methods described herein may be implemented. For example, the core network 405 may include an example architecture of a fifth generation (5G) next generation (NG) core network included in a 5G wireless telecommunications system. Although the example architecture of the core network 405 shown in FIG. 4 may be an example of a service-based architecture, in some aspects, the core network 405 may be implemented as a reference-point architecture and/or a 4G core network, among other examples.

As shown in FIG. 4, the core network 405 may include a number of functional elements. The functional elements may include, for example, a network slice selection function (NSSF) 410, a network exposure function (NEF) 415, an authentication server function (AUSF) 420, a unified data management (UDM) component 425, a policy control function (PCF) 430, an application function (AF) 435, an access and mobility management function (AMF) 440, one or more session management functions (SMF) 445, and/or a user plane function (UPF) 450, among other examples. These functional elements may be communicatively connected via a message bus 455. Each of the functional elements shown in FIG. 4 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 410 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NSSF 410 may determine a set of network slice policies to be applied at the wireless network 100. For example, the NSSF 410 may apply one or more UE route selection policy (URSP) rules. In some aspects, the NSSF 410 may select a network slice based on a mapping of a data network name (DNN) field included in a route selection description (RSD) to the DNN field included in a traffic descriptor selected by the UE 120. By providing network slicing, the NSSF 410 allows an operator to deploy multiple substantially independent end-to-end networks potentially with the same infrastructure. In some implementations, each slice may be customized for different services.

The NEF 415 may include one or more devices that support exposure of capabilities and/or events in the wireless telecommunications system to help other entities in the wireless telecommunications system discover network services. The AUSF 420 may include one or more devices that act as an authentication server and support the process of authenticating the UE 120 in the wireless telecommunications system.

The UDM 425 may include one or more devices that store user data and profiles in the wireless telecommunications system. In some aspects, the UDM 425 may be used for fixed access and/or mobile access, among other examples, in the core network 405.

The PCF 430 may include one or more devices that provide a policy framework that incorporates network slicing, roaming, packet processing, and/or mobility management, among other examples. In some aspects, the PCF 430 may include one or more URSP rules used by the NSSF 410 to select network slice instances for the UE 120.

The AF 435 may include one or more devices that support application influence on traffic routing, access to the NEF 415, and/or policy control, among other examples. The AMF 440 may include one or more devices that act as a termination point for non-access stratum (NAS) signaling and/or mobility management, among other examples. In some aspects, the AMF 440 may receive (e.g., from a UE 120 via the wireless network 100) a NAS message including a multicast broadcast services (MBS) session status information element (IE), identify an SMF 445 based at least in part on an MBS context associated with a UE 120 and an MBS session identifier, and forward the MBS session status indication to the SMF 445, as described herein. In some aspects, the AMF 440 may include a communication manager 442. As described in more detail elsewhere herein, the communication manager 442 may receive a NAS message including an MBS session status IE, wherein the MBS session status information IE includes an MBS session identifier corresponding to an MBS session of a UE 120 and an MBS session status indication indicating a status of the MBS session; identify an SMF 445 (e.g., an SMF node) based at least in part on an MBS context associated with the UE 120 and the MBS session identifier; and forward the MBS session status indication to the SMF 445. Additionally, or alternatively, the communication manager 442 may perform one or more other operations described herein.

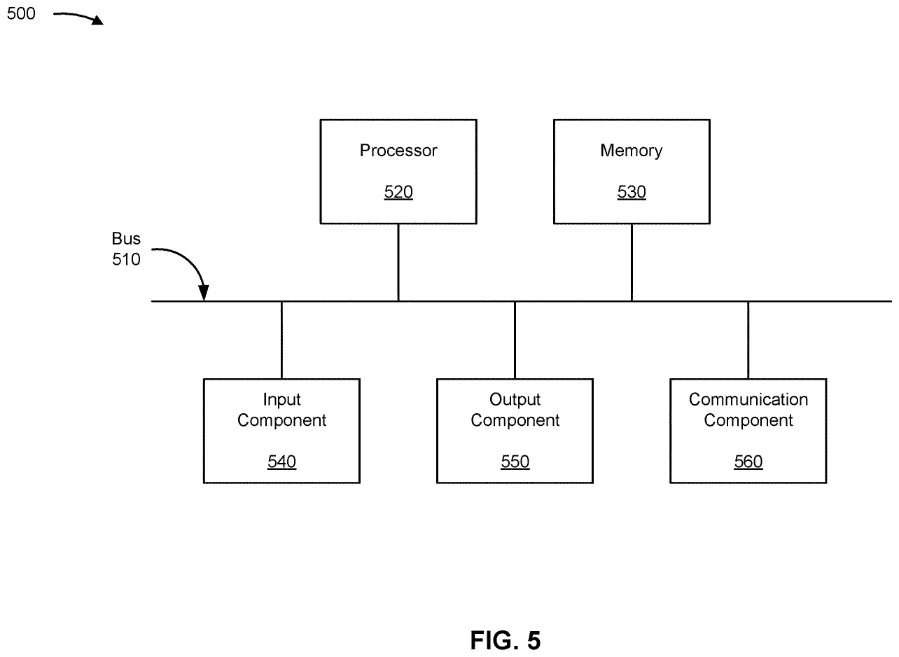

In some aspects, the AMF 440 includes means for receiving a NAS message including an MBS session status IE, wherein the MBS session status information IE includes an MBS session identifier corresponding to an MBS session of a UE 120 and an MBS session status indication indicating a status of the MBS session; means for identifying SMF 445 based at least in part on an MBS context associated with the UE 120 and the MBS session identifier; and/or means for forwarding the MBS session status indication to the SMF 445. In some aspects, the means for the AMF 440 to perform operations described herein may include, for example, one or more of communication manager 442 and/or one or more components of a device 500 as described with respect to FIG. 5 (e.g., a processor 520, a memory 530, an input component 540, an output component 550, and/or a communication component 560).

The SMF 445 may include one or more devices that support the establishment, modification, and release of communication sessions in the wireless telecommunications system. For example, the SMF 445 may configure traffic steering policies at the UPF 450 and/or enforce UE IP address allocation and policies, among other examples. In some aspects, the SMF 445 may receive an indication to release an MBS session of a UE 120, and may release the MBS session based at least in part on the indication, as described herein.

In some aspects, the SMF 445 may include a communication manager 446. As described in more detail elsewhere herein, the communication manager 446 may receive an indication to release an MBS session of a UE 120, the indication including at least one of an MBS session status indication associated with the MBS session, the MBS session status indication indicating that the MBS session is inactive, or an indication that the UE has been removed from the MBS session; and release the MBS session based at least in part on the indication to release the MBS session. Additionally, or alternatively, the communication manager 446 may perform one or more other operations described herein.

In some aspects, the SMF 445 includes means for receiving an indication to release an MBS session of a UE 120, the indication including at least one of an MBS session status indication associated with the MBS session, the MBS session status indication indicating that the MBS session is inactive, or an indication that the UE 120 has been removed from the MBS session; and/or means for releasing the MBS session based at least in part on the indication to release the MBS session. In some aspects, the means for the SMF 445 to perform operations described herein may include, for example, one or more of communication manager 446, and/or one or more components of a device 500 as described with respect to FIG. 5 (e.g., a processor 520, a memory 530, an input component 540, an output component 550, and/or a communication component 560).

The UPF 450 may include one or more devices that serve as an anchor point for intraRAT and/or interRAT mobility. In some aspects, the UPF 450 may apply rules to packets, such as rules pertaining to packet routing, traffic reporting, and/or handling user plane QoS, among other examples.

The message bus 455 may be a logical and/or physical communication structure for communication among the functional elements. Accordingly, the message bus 455 may permit communication between two or more functional elements, whether logically (e.g., using one or more application programming interfaces (APIs), among other examples) and/or physically (e.g., using one or more wired and/or wireless connections).

The number and arrangement of devices, elements, and networks shown in FIG. 4 are provided as an example. In practice, there may be additional devices, elements, and/or networks, fewer devices, elements, and/or networks, different devices, elements, and/or networks, or differently arranged devices, elements, and/or networks than those shown in FIG. 4. Furthermore, two or more devices or elements shown in FIG. 4 may be implemented within a single device or element, or a single device or element shown in FIG. 4 may be implemented as multiple, distributed devices or elements. Additionally, or alternatively, a set of devices or elements (e.g., one or more devices or elements) of example 400 may perform one or more functions described as being performed by another set of devices or elements of example environment 400.

FIG. 5 is a diagram of example components of a device 500 associated with the core network 405, in accordance with the present disclosure. The device 500 may correspond to one or more of the NSSF 410, the NEF 415, the AUSF 420, the UDM 425, the PCF 430, the AF 435, the AMF 440, the SMF 445, and/or the UPF 450. In some implementations, NSSF 410, the NEF 415, the AUSF 420, the UDM 425, the PCF 430, the AF 435, the AMF 440, the SMF 445, and/or the UPF 450 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, an accelerometer, a gyroscope, and/or an actuator. The output component 550 may enable the device 500 to provide output, such as via a display, a speaker, and/or a light-emitting diode.

The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

A wireless communication system may support an MBS service that provides multicast services and broadcast services to UEs. A multicast service is provided to a group of UEs. The group of UEs receiving a particular multicast service share, at least in part, network resources needed to provide the service. A broadcast service is provided to all the UEs. A multicast service may be activated in the network when there are UEs interested in receiving the service. A multicast service may be deactivated in the network when there are no longer any UEs receiving the service. Since multicast services consume network resources, it is in the interest of the network operator to have precise and timely information about UEs that are actively receiving the service so that the service can be deactivated if there are no UEs receiving the service.

For a multicast service, there are two delivery types: individual delivery, where an MBS traffic flow is delivered to a single UE, and shared delivery, where MBS traffic is delivered to a group of UEs (e.g., in a set of shared resources). For either delivery type of the multicast service, a PDU session is established between a UE receiving the multicast service and a core network. A PDU session identifies the physical resources in the network that are assigned to data exchanged via the session. For example, a PDU session identifies a rate of data packets exchanged via the PDU session, quality of service (QOS) parameters (e.g., maximum delay, maximum jitter, or the like) of the PDU session and one or more Internet protocol (IP) addresses associated with a source and a destination of the data packets exchanged via the PDU session. A UE establishes a PDU session with the network using a PDU session establishment procedure. According to the PDU session establishment procedure, the UE transmits a PDU session establishment request message. The network may respond with a PDU session establishment accept message to indicate that the PDU session has been established.

A session during which a UE receives a multicast service (e.g., via a PDU session) is referred to as an MBS session. There can be multiple MBS sessions associated with a PDU session (e.g., multiple MBS sessions of a UE can use the same PDU session of the UE). A UE can establish an MBS session during the PDU session establishment procedure of the associated PDU session by providing, in the PDU session establishment request message, an indication of a request to join an MBS session along with an identity of the MBS session the UE wants to join.

A PDU session can be released by the UE or by the network via the PDU session release procedure. If the PDU session is released, then all of the associated MBS sessions are implicitly released. This kind of an implicit release of an MBS session can also be referred to as a “local release.”

If a UE performs a local release of an MBS session, then the network is not explicitly informed about the local release. In some scenarios, the network may infer that an MBS session has been released by the UE. For example, when a PDU session is released, the network may infer that the UE has locally released the associated MBS sessions and the network can also locally release the MBS sessions. In an example scenario, a UE has an active MBS session associated with a PDU session. While the UE is in an RRC connected mode, the UE actively receives MBS traffic associated with the MBS session. In one example, the UE itself (e.g., rather than the user) may locally leave the MBS session. This may occur if, for example, the UE sends a PDU session release request message to release the PDU session associated with the MBS session, and the network rejects the request and transmits a PDU session release reject message to the UE. Rejection of the PDU session release may occur when, for example, the message from the UE is incorrect (e.g., includes an incorrect PDU session identity). In this example, the UE releases the PDU session locally along with the associated MBS session. As another example, the UE itself may locally leave the MBS session during an inter-system change from an N1 mode (5G) to S1 mode (LTE) and an associated transfer of the PDU session. Here, since LTE does not support MBS, the UE may locally release the associated MBS session. The inter-system change may not be successful or can be aborted and the UE may stay in the NI mode. A status of the MBS session from the perspective of the UE and a status of the MBS session from the perspective of the network may differ in this example.

The local release of MBS sessions by a UE and a network creates a possibility of a loss of synchronization between the UE and the network with respect to a status of an MBS session. For example, the UE may have performed a local release of an MBS session, but the network did not infer that the local release of the MBS session took place in the UE. As a result, the network incorrectly considers the MBS session as active in the UE. Similarly, the UE may incorrectly consider an MBS session as active in a network after the network has implicitly released the MBS session.

A UE may in some scenarios be operating in a radio resource control (RRC) inactive mode. The RRC inactive mode is a mode at the RRC layer in which the UE is connected to a network in the sense that there is a UE context in the network, but there is no active signaling connection between the UE and the network. To transmit or receive traffic to or from the network, the UE in the RRC inactive mode would need to resume the signaling connection with the network. It follows that a UE in the RRC inactive mode cannot actively receive MBS traffic associated with an MBS session. Thus, the UE in the RRC inactive may have one or more active MBS sessions, associated with one or more PDU sessions, but the UE is not actively receiving MBS traffic associated with the one or more MBS sessions.

In an example scenario, a UE has an active MBS session associated with a PDU session. While the UE is in an RRC connected mode, the UE actively receives MBS traffic associated with the MBS session. In one example, the MBS session becomes inactive, and so radio resources associated with the MBS session are released and the UE is moved (e.g., by the network) to the RRC inactive mode. Here, while operating in the RRC inactive mode, the UE (e.g., based on user input) leaves the MBS session. In this example, the UE locally leaves the MBS session, meaning that the network is not aware that the UE has left the MBS session. Further, the PDU session associated with the MBS session need not be released since the PDU session may also be used for other traffic (e.g., Internet traffic). In another example, the MBS session becomes inactive, and the UE is moved (e.g., by the network) to an RRC idle mode (e.g., if the RRC inactive mode is not supported by the network, if the PDU session is only for MBS and the UE has no other active PDU sessions, or the like). Here, while operating in the RRC idle mode, the UE may leave the MBS session based on user input. In this example, the UE locally leaves the MBS session, meaning that the network is not aware that the UE has left the MBS session. Further, the PDU session associated with the MBS session need not be released since the PDU session may also be used for other traffic.

Typically, to leave an MBS session the UE moves to the RRC connected mode and initiates a PDU session modification procedure for the associated PDU session. Here, the UE includes a leave request in a PDU session modification request message that is provided to the network.

However, as this typical approach requires the UE to move to the connected mode, UE resources (e.g., battery power, processing resources, or the like) may be wasted (e.g., when the UE has no other reason to move to the RRC connected mode). Further, the typical approach increases signaling overhead. In this scenario, because the MBS session is inactive, there is no urgency to release the MBS session from the perspective of a core network. Therefore, the release of the MBS session can be delayed until the UE needs to resume the signaling connection for another reason (e.g., a mobility registration update, a service request for other traffic or applications, or the like).

Some techniques and apparatuses described herein provide MBS session status reporting. In some aspects, a UE (e.g., a UE 120) may leave an MBS session without leaving a PDU session associated with the MBS session, and may transmit a signaling message after leaving the MBS session, where the signaling message includes an IE comprising an MBS session identifier associated with the MBS session and an MBS session status indication associated with the MBS session. In some aspects, a core network node (e.g., an AMF 440) may receive the signaling message (e.g., a NAS message) including the MBS session status IE, identify an SMF node (e.g., an SMF 445) based at least in part on an MBS context associated with the UE 120 and the MBS session identifier, and forward the MBS session status indication to the SMF node. In some aspects, the SMF node may receive the MBS session status indication associated with the MBS session, and release the MBS session. In some aspects, the UE need not transmit the signaling message until the UE moves to RRC connected mode for another reason. In this way, UE resources may be conserved and signaling overhead may be decreased.

Additionally, or alternatively, a UE (e.g., a UE 120) may in some aspects leave an MBS session without leaving a PDU session associated with the MBS session, and may transmit, for reception by a RAN node (e.g., a network node 110) and based on leaving the MBS session, a signaling message including an indication that the UE has left the MBS session. In some aspects, the RAN node may receive the signaling message including the indication that the UE has left the MBS session, and may remove the UE from the MBS session. Further, in some aspects, the RAN node may transmit an indication that the UE has been removed from the MBS session to a core network node (e.g., an SMF 445). In some aspects, the core network node may receive the indication that the UE has been removed from the MBS session, and may release the MBS session based at least in part on the indication. Additional details are provided below. In some aspects, the UE can transmit the signaling message to the RAN node prior to moving to the RRC connected mode. In this way, UE resources may be conserved and signaling overhead may be decreased. Further, releasing the MBS session in a RAN may improve radio resource management from the perspective of the RAN. Additional details are provided below.

FIGS. 6A and 6B are diagrams illustrating examples 600 and 650, respectively, associated with MBS session status reporting, in accordance with the present disclosure.

As shown in FIG. 6A, example 600 includes communication among a UE 120, an AMF 440, and an SMF 445. In some aspects, the UE 120 may be included in a wireless network, such as a wireless network 100 (not shown). The UE 120 may communicate with the AMF 440 via a wireless access link supported by the wireless network 100. The AMF 440 may communicate with the SMF 445 via a message bus 455 of a core network 405.

As shown by reference 602, the UE 120 may leave an MBS session without leaving a PDU session associated with the MBS session. For example, the UE 120 may locally leave the MBS session (e.g., based on user input, based on a decision by the UE 120 itself, or the like). Here, the UE locally leaves the MBS session. However, the wireless network 100 (e.g., devices in a RAN) and the core network 405 (e.g., devices in a core network) are not aware that the UE 120 has left the MBS session.

As shown by reference 604, the UE 120 may transmit, and the AMF 440 may receive, a signaling message after leaving the MBS session. In some aspects, the signaling message includes an IE comprising an MBS session identifier associated with the MBS session and an MBS session status indication associated with the MBS session.

In some aspects, the UE 120 is operating in the RRC inactive mode at a time of leaving the MBS session. In some such aspects, the signaling message is an initial NAS message, and the UE 120 resumes a signaling connection prior to transmitting the signaling message.

Alternatively, in some aspects, the UE 120 is operating in an RRC idle mode at a time of leaving the MBS session. In some such aspects, the signaling message is an initial NAS message, and the UE 120 establishes a signaling connection prior to transmitting the signaling message. In some aspects, the initial NAS message is a registration update request message. In some aspects, the initial NAS message is a service request message.

In some aspects, the UE 120 is operating in the RRC connected mode at a time of leaving the MBS session. In some such aspects, the signaling message is an uplink NAS message. The uplink NAS message may be, for example, an initial NAS message or an uplink NAS transport message.

In some aspects, the IE is an MBS session status update IE. The MBS session status update IE is an IE that includes information indicating the status of one or more MBS sessions of the UE 120. The information indicating the status of a given MBS session may include an MBS session identifier associated with the MBS session and an MBS session status indication associated with the MBS session, with the MBS session status indication indicating a status of the MBS session (e.g., active, inactive, or the like). In some aspects, the MBS session status update IE includes information indicating the status of multiple MBS sessions. For example, in some aspects, the MBS session status update IE may include information indicating a status of each MBS session of the UE 120. As one particular example, the MBS session status update IE may include a first set of bits indicating an MBS session identifier associated with a first MBS session, a second set of bits indicating a status of the first MBS session (e.g., active), a third set of bits indicating an MBS session identifier associated with a second MBS session, a fourth set of bits indicating a status of the second MBS session (e.g., inactive), and so on. In some aspects, the MBS session identifier associated with an MBS session may include an MBS session identity or a temporary mobile group identifier (TMGI). In some aspects, the MBS session status indication is a one-bit indication (e.g., a value of 0 indicating inactive, a value of 1 indicating active). In some aspects, the MBS session status indication is a two-bit binary value. In some aspects, the MBS session status indication is a three-bit binary value. In some aspects, the MBS session status update IE may include one or more other items of information, such as information indicating a length of the MBS session status update IE or information identifying the MBS session status update IE, among other examples.

As shown by reference 606, the AMF 440 may identify an SMF 445 based at least in part on an MBS context associated with the UE 120 and the MBS session identifier. For example, the AMF 440 may receive the signaling message (e.g., the NAS message) comprising the MBS session status IE that indicates the status of the MBS session, with the MBS session being identified using the MBS session identifier. Next, the AMF 440 may retrieve an MBS context for the UE 120, and may identify the SMF 445 that manages the MBS session based at least in part on the retrieved MBS context and the MBS session identifier. The AMF 440 may perform these operations for one or more of the MBS sessions indicated in the MBS session status update IE (e.g., such that the AMF 440 identifies one or more SMFs 445, each associated with one or more MBS sessions indicated in the MBS session status update IE).

As shown by reference 608, the AMF 440 may forward the MBS session status indication and the MBS session identifier to the SMF 445, and the SMF 445 may receive the MBS session status indication and the associated MBS session identifier. In example 600, the MBS status indication indicates that the MBS session is inactive (e.g., since the UE 120 left the MBS session) and, therefore, the MBS status indication may serve as an indication to release the MBS session.

Therefore, as shown by reference 610, the SMF 445 may release the MBS session based at least in part on the indication to release the MBS session. In some aspects, in association with releasing the MBS session, the SMF 445 may remove the MBS session from a PDU session context associated with the MBS session and from a UE context associated with the UE 120.

The SMF 445 may perform these operations for one or more of the MBS sessions for which an indication to release is received by the SMF 445.

As shown in FIG. 6B, example 650 includes communication among a UE 120, a network node 110, and a core network 405. In some aspects, the UE 120 and the network node 110 may be included in a wireless network, such as a wireless network 100 (not shown). The UE 120 and the network node 110 may communicate via a wireless access link supported by the wireless network 100. The network node 110 may communicate with the core network 405 (e.g., with one or more devices in the core network 405, such as an SMF 445) via one or more wireless or wired connections.

As shown by reference 652, the UE 120 may leave an MBS session without leaving a PDU session associated with the MBS session. For example, the UE 120 may locally leave the MBS session (e.g., based on user input). Here, the UE locally leaves the MBS session. However, the wireless network 100 (e.g., devices in a RAN) and the core network 405 (e.g., devices in a core network) are not aware that the UE 120 has left the MBS session.

As shown by reference 654, based on leaving the MBS session, the UE 120 may transmit, and the network node 110 may receive, a signaling message including an indication that the UE has left the MBS session. In some aspects, the UE 120 may transmit the signaling message for reception by a core network node, such as a network node 110. In some such aspects, the UE 120 is operating in the RRC inactive mode at a time at which the signaling message is transmitted. Alternatively, in some such aspects, the UE 120 is operating in an RRC idle mode at a time at which the signaling message is transmitted. In some aspects, the signaling message is communicated in a message (e.g., Msg3) associated with a random access channel (RACH) procedure. In some aspects, communication of the signaling message in the RACH message provides efficiency in terms of signaling overhead. In some aspects, a legacy small data transfer (SDT) procedure can be used in association with communicating the signaling message.

In some aspects, the indication that the UE 120 has left the MBS session includes an MBS session identifier associated with the MBS session. The MBS session identifier may include, for example, an MBS session identity or a TMGI.

As shown by reference 656, the network node 110 may remove the UE 120 from the MBS session based at least in part on the indication that the UE 120 has left the MBS session and the MBS session identifier. In some aspects, in association with removing the UE 120 from the MBS session, the network node 110 may remove radio resources associated with the UE 120 from a set of radio resources allocated to the MBS session. In some aspects, removing the radio resources associated with the UE 120 improves radio resource management from the perspective of the wireless network 100 (e.g., the RAN including the network node 110).

As shown by reference 658, the network node 110 may in some aspects transmit, and the SMF 445 may receive (e.g., via the core network 405), an indication that the UE 120 has been removed from the MBS session. Here, the indication that the UE 120 has been removed from the MBS session may serve as an indication to release the MBS session. Therefore, as shown by reference 660, the SMF 445 may release the MBS session based at least in part on the indication to release the MBS session. In some aspects, in association with releasing the MBS session, the SMF 445 may remove the MBS session from a PDU session context associated with the MBS session and from a UE context associated with the UE 120.

Notably, the techniques associated with example 600 in FIG. 6A may be based on a NAS protocol between the UE 120 and the core network 405, while the techniques associated with example 650 in FIG. 6B may be based on signaling between the UE 120 and the wireless network 100 (e.g., the RAN). Therefore, while the techniques associated with example 600 and the techniques associated with example 650 can be used as alternatives, these techniques can also be used to complement one another. For example, the UE 120 can inform the network node 110 (e.g., the RAN) regarding leaving an MBS session using the techniques associated with example 650 (e.g., immediately upon leaving the MBS session), and can synchronize with the core network 405 regarding the MBS session at a later time (e.g., after the UE 120 resumes a signaling connection) using the techniques associated with example 600.

As indicated above, FIGS. 6A and 6B are provided as examples. Other examples may differ from what is described with respect to FIGS. 6A and 6B.

FIG. 7 is a diagram illustrating an example process 700 performed, for example, by a UE, in accordance with the present disclosure. Example process 700 is an example where the UE (e.g., UE 120) performs operations associated with MBS session status reporting.

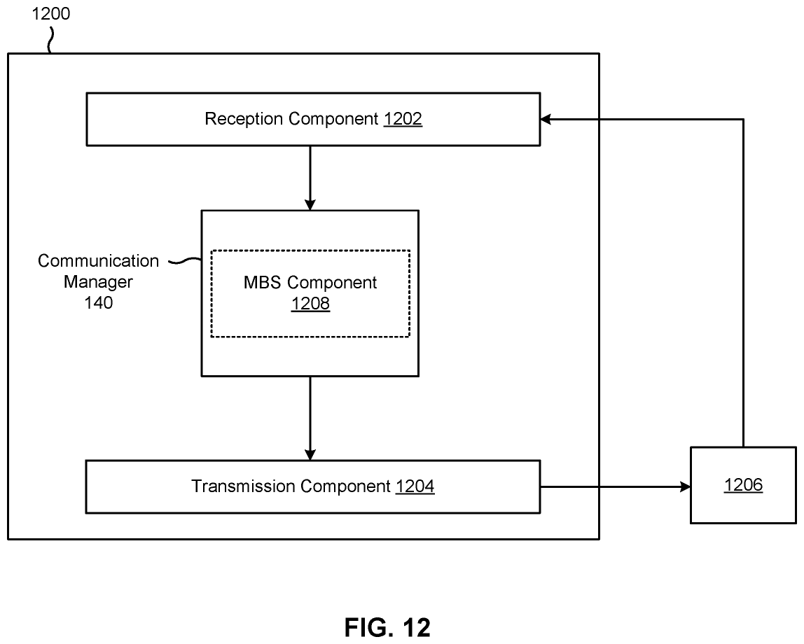

As shown in FIG. 7, in some aspects, process 700 may include leaving an MBS session without leaving a PDU session associated with the MBS session (block 710). For example, the UE (e.g., using communication manager 140 and/or MBS component 1208, depicted in FIG. 12) may leave an MBS session without leaving a PDU session associated with the MBS session, as described above.

As further shown in FIG. 7, in some aspects, process 700 may include transmitting a signaling message after leaving the MBS session, the signaling message including an IE comprising an MBS session status indication associated with the MBS session (block 720). For example, the UE (e.g., using communication manager 140 and/or transmission component 1204, depicted in FIG. 12) may transmit a signaling message after leaving the MBS session, the signaling message including an IE comprising an MBS session status indication associated with the MBS session, as described above.

Process 700 may include additional aspects, such as any single aspect or any combination of aspects described below and/or in connection with one or more other processes described elsewhere herein.

In a first aspect, the IE is an MBS session status update IE.

In a second aspect, alone or in combination with the first aspect, the UE is operating in a radio resource control inactive mode at a time of leaving the MBS session and the signaling message is an initial non-access stratum message, and process 700 includes resuming a signaling connection prior to transmitting the signaling message.

In a third aspect, alone or in combination with one or more of the first and second aspects, the UE is operating in an idle mode at a time of leaving the MBS session and the signaling message is an initial non-access stratum message, and process 700 includes establishing a signaling connection prior to transmitting the signaling message.

In a fourth aspect, alone or in combination with one or more of the first through third aspects, the signaling message is an initial NAS message, the initial NAS message being a registration update request message or a service request message.

In a fifth aspect, alone or in combination with one or more of the first through fourth aspects, the UE is operating in a connected mode and the signaling message is an uplink NAS message.

In a sixth aspect, alone or in combination with one or more of the first through fifth aspects, the uplink NAS message is an initial NAS message or an uplink NAS transport message.

In a seventh aspect, alone or in combination with one or more of the first through sixth aspects, the IE includes an MBS session identifier associated with the MBS session of the UE.

In an eighth aspect, alone or in combination with one or more of the first through seventh aspects, the MBS session identifier includes at least one of an MBS session identity or a temporary mobile group identifier.

In a ninth aspect, alone or in combination with one or more of the first through eighth aspects, the MBS session status indication is a one-bit indication, a two-bit binary value, or a three-bit binary value.

In a tenth aspect, alone or in combination with one or more of the first through ninth aspects, the IE includes multiple MBS session identifiers associated with multiple MBS sessions of the UE, and information indicating a status of each MBS session of the multiple MBS sessions of the UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with MBS session status reporting.

As shown in FIG. 8, in some aspects, process 800 may include leaving an MBS session without leaving a PDU session associated with the MBS session (block 810). For example, the UE (e.g., using communication manager 140 and/or MBS component 1208, depicted in FIG. 12) may leave an MBS session without leaving a PDU session associated with the MBS session, as described above.

As further shown in FIG. 8, in some aspects, process 800 may include transmitting, for reception by a RAN node and based on leaving the MBS session, a signaling message including an indication that the UE has left the MBS session (block 820). For example, the UE (e.g., using communication manager 140 and/or transmission component 1204, depicted in FIG. 12) may transmit, for reception by a RAN node (e.g., a network node 110) and based on leaving the MBS session, a signaling message including an indication that the UE has left the MBS session, as described above.

Process 800 may include additional aspects, such as any single aspect or any combination of aspects described below and/or in connection with one or more other processes described elsewhere herein.

In a first aspect, the UE is operating in a radio resource control inactive mode at a time at which the signaling message is transmitted.

In a second aspect, alone or in combination with the first aspect, the UE is operating in an idle mode at time at which the signaling message is transmitted.

In a third aspect, alone or in combination with one or more of the first and second aspects, the indication that the UE has left the MBS session includes an MBS session identifier associated with the MBS session.

In a fourth aspect, alone or in combination with one or more of the first through third aspects, the MBS session identifier includes at least one of an MBS session identity or a temporary mobile group identifier.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

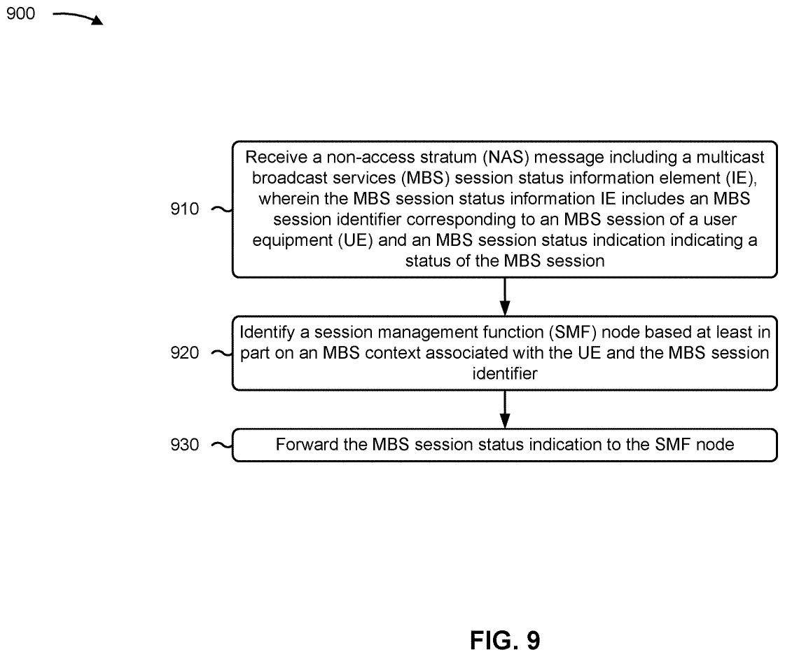

FIG. 9 is a diagram illustrating an example process 900 performed, for example, by a core network node, in accordance with the present disclosure. Example process 900 is an example where the core network node (e.g., AMF 440) performs operations associated with MBS session status reporting.

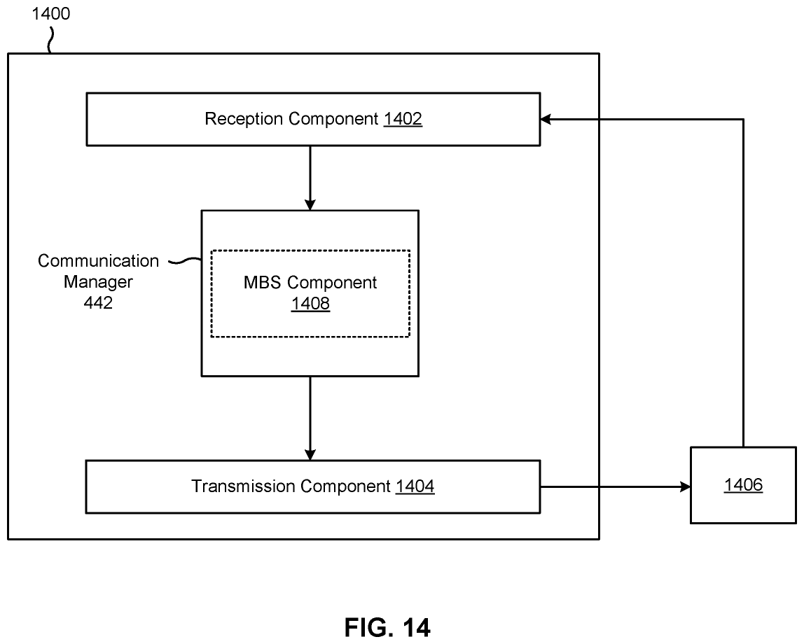

As shown in FIG. 9, in some aspects, process 900 may include receiving a NAS message including an MBS session status IE, wherein the MBS session status information IE includes an MBS session identifier corresponding to an MBS session of a UE and an MBS session status indication indicating a status of the MBS session (block 910). For example, the core network node (e.g., using communication manager 442 and/or reception component 1402, depicted in FIG. 14) may receive a NAS message including an MBS session status IE, wherein the MBS session status information IE includes an MBS session identifier corresponding to an MBS session of a UE (e.g., a UE 120) and an MBS session status indication indicating a status of the MBS session, as described above.

As further shown in FIG. 9, in some aspects, process 900 may include identifying an SMF node based at least in part on an MBS context associated with the UE and the MBS session identifier (block 920). For example, the core network node (e.g., using communication manager 442 and/or MBS component 1408, depicted in FIG. 14) may identify an SMF node (e.g., an SMF 445) based at least in part on an MBS context associated with the UE and the MBS session identifier, as described above.

As further shown in FIG. 9, in some aspects, process 900 may include forwarding the MBS session status indication to the SMF node (block 930). For example, the core network node (e.g., using communication manager 442 and/or transmission component 1404, depicted in FIG. 14) may forward the MBS session status indication to the SMF node, as described above.

Process 900 may include additional aspects, such as any single aspect or any combination of aspects described below and/or in connection with one or more other processes described elsewhere herein.

In a first aspect, the NAS message is an initial NAS message, the initial NAS message being a registration update request message or a service request message.

In a second aspect, alone or in combination with the first aspect, the NAS message is an uplink NAS transport message.

In a third aspect, alone or in combination with one or more of the first and second aspects, the MBS session identifier includes at least one of an MBS session identity or a temporary mobile group identifier.

In a fourth aspect, alone or in combination with one or more of the first through third aspects, the MBS session status update IE includes multiple MBS session identifiers associated with multiple MBS sessions of the UE, and information indicating a status of each MBS session of the multiple MBS sessions of the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a RAN node, in accordance with the present disclosure. Example process 1000 is an example where the RAN node (e.g., network node 110) performs operations associated with MBS session status reporting.

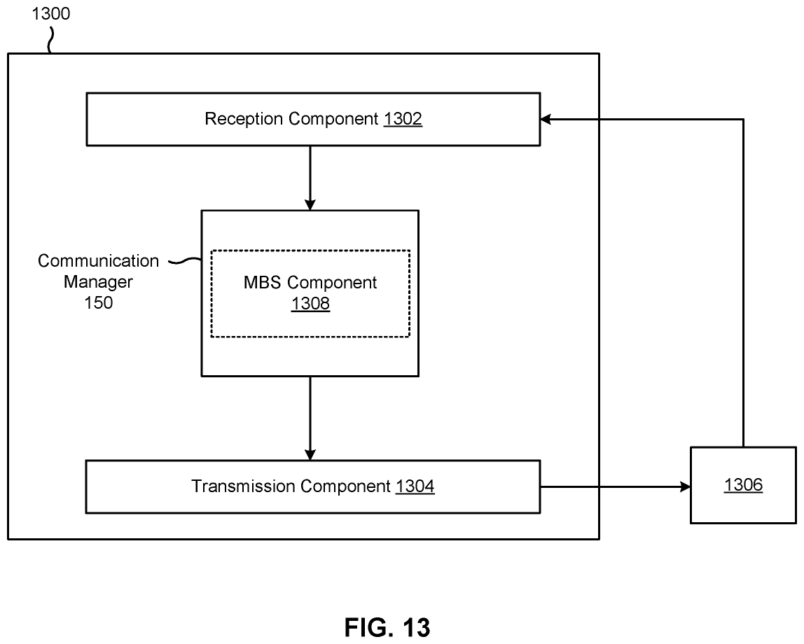

As shown in FIG. 10, in some aspects, process 1000 may include receiving a signaling message including an indication that a UE has left an MBS session (block 1010). For example, the RAN node (e.g., using communication manager 150 and/or reception component 1302, depicted in FIG. 13) may receive a signaling message including an indication that a UE (e.g., a UE 120) has left an MBS session, as described above.

As further shown in FIG. 10, in some aspects, process 1000 may include removing the UE from the MBS session based at least in part on the indication that the UE has left the MBS session (block 1020). For example, the RAN node (e.g., using communication manager 150 and/or MBS component 1308, depicted in FIG. 13) may remove the UE from the MBS session based at least in part on the indication that the UE has left the MBS session, as described above.

Process 1000 may include additional aspects, such as any single aspect or any combination of aspects described below and/or in connection with one or more other processes described elsewhere herein.

In a first aspect, removing the UE from the MBS session comprises removing radio resources associated with the UE from a set of radio resources allocated to the MBS session.

In a second aspect, alone or in combination with the first aspect, process 1000 includes transmitting an indication that the UE has been removed from the MBS session to a core network node.

In a third aspect, alone or in combination with one or more of the first and second aspects, the indication that the UE has left the MBS session includes an MBS session identifier associated with the MBS session.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

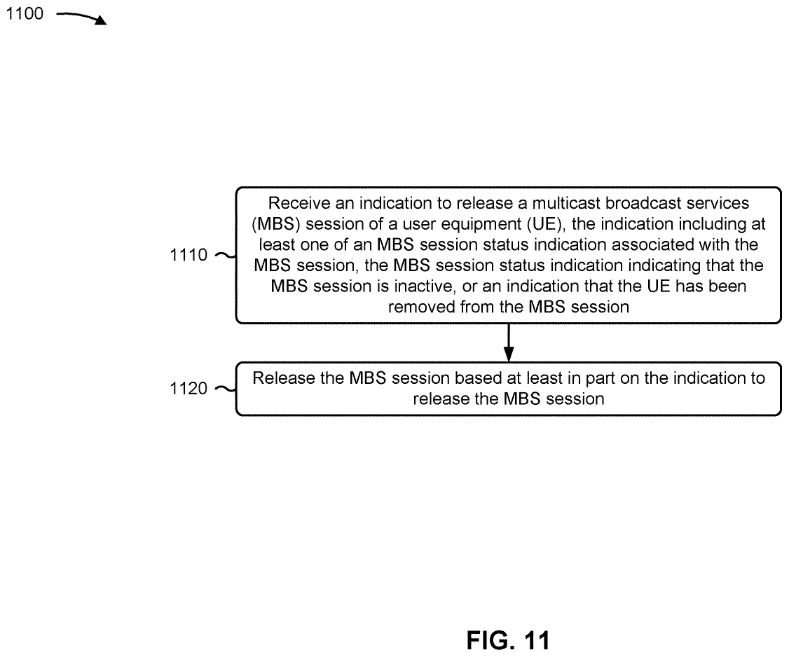

FIG. 11 is a diagram illustrating an example process 1100 performed, for example, by a core network node, in accordance with the present disclosure. Example process 1100 is an example where the core network node (e.g., an SMF 445) performs operations associated with MBS session status reporting.

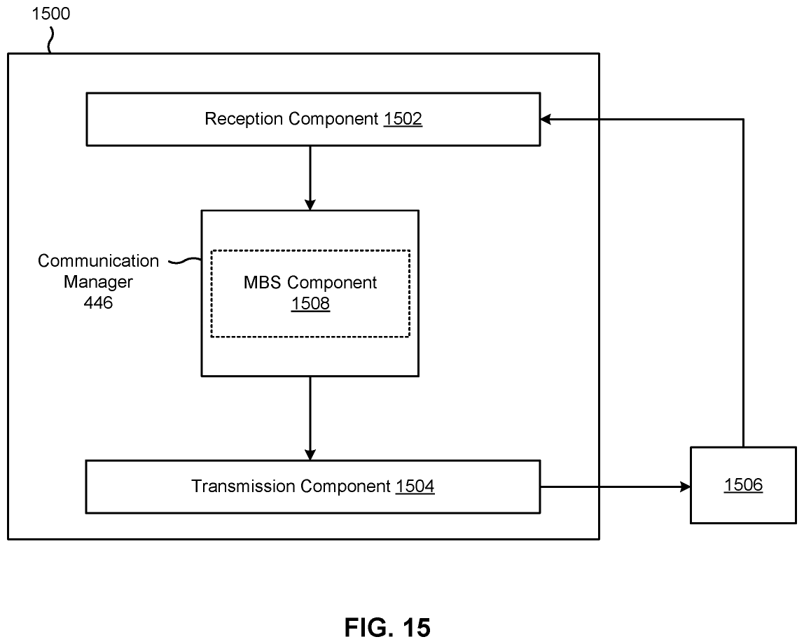

As shown in FIG. 11, in some aspects, process 1100 may include receiving an indication to release an MBS session of a UE, the indication including at least one of: an MBS session status indication associated with the MBS session, the MBS session status indication indicating that the MBS session is inactive, or an indication that the UE has been removed from the MBS session (block 1110). For example, the core network node (e.g., using communication manager 446 and/or reception component 1502, depicted in FIG. 15) may receive an indication to release an MBS session of a UE (e.g., a UE 120), the indication including at least one of: an MBS session status indication associated with the MBS session, the MBS session status indication indicating that the MBS session is inactive, or an indication that the UE has been removed from the MBS session, as described above.

As further shown in FIG. 11, in some aspects, process 1100 may include releasing the MBS session based at least in part on the indication to release the MBS session (block 1120). For example, the core network node (e.g., using communication manager 446 and/or MBS component 1508, depicted in FIG. 15) may release the MBS session based at least in part on the indication to release the MBS session, as described above.

Process 1100 may include additional aspects, such as any single aspect or any combination of aspects described below and/or in connection with one or more other processes described elsewhere herein.

In a first aspect, releasing the MBS session comprises removing the MBS session from a PDU session context associated with the MBS session and a UE context associated with the UE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include an MBS component 1208, among other examples.

In some aspects, the apparatus 1200 may be configured to perform one or more operations described herein in connection with FIGS. 6A and 6B. Additionally, or alternatively, the apparatus 1200 may be configured to perform one or more processes described herein, such as process 700 of FIG. 7, process 800 of FIG. 8, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The MBS component 1208 may leave an MBS session without leaving a PDU session associated with the MBS session. In some aspects, the transmission component 1204 may transmit a signaling message after leaving the MBS session, the signaling message including an IE comprising an MBS session status indication associated with the MBS session. In some aspects, the transmission component 1204 may transmit, for reception by a RAN node and based on leaving the MBS session, a signaling message including an indication that the UE has left the MBS session.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components.

Additionally, or alternatively, a set of (one or more) components shown in FIG. 12 may perform one or more functions described as being performed by another set of components shown in FIG. 12.

FIG. 13 is a diagram of an example apparatus 1300, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, a core network node, or another device) using the reception component 1302 and the transmission component 1304. As further shown, the apparatus 1300 may include the communication manager 150. The communication manager 150 may include an MBS component 1308, among other examples.

In some aspects, the apparatus 1300 may be configured to perform one or more operations described herein in connection with FIGS. 6A and 6B. Additionally, or alternatively, the apparatus 1300 may be configured to perform one or more processes described herein, such as process 1000 of FIG. 10. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2.

Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The reception component 1302 may receive a signaling message including an indication that a UE has left an MBS session. The MBS component 1308 may remove the UE from the MBS session based at least in part on the indication that the UE has left the MBS session.

The transmission component 1304 may transmit an indication that the UE has been removed from the MBS session to a core network node.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a core network node (e.g., an AMF), or a core network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 442. The communication manager 442 may include an MBS component 1408, among other examples.

In some aspects, the apparatus 1400 may be configured to perform one or more operations described herein in connection with FIGS. 6A and 6B. Additionally, or alternatively, the apparatus 1400 may be configured to perform one or more processes described herein, such as process 900 of FIG. 9. In some aspects, the apparatus 1400 and/or one or more components shown in FIG. 14 may include one or more components of the core network node described in connection with FIG. 5. Additionally, or alternatively, one or more components shown in FIG. 14 may be implemented within one or more components described in connection with FIG. 5. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the core network node described in connection with FIG. 5.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the core network node described in connection with FIG. 5. In some aspects, the transmission component 1404 may be co-located with the reception component 1402 in a transceiver.

The reception component 1402 may receive a NAS message including an MBS session status IE, wherein the MBS session status information IE includes an MBS session identifier corresponding to an MBS session of a UE and an MBS session status indication indicating a status of the MBS session. The MBS component 1408 may identify an SMF node based at least in part on an MBS context associated with the UE and the MBS session identifier. The transmission component 1404 may forward the MBS session status indication to the SMF node. The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components.

Additionally, or alternatively, a set of (one or more) components shown in FIG. 14 may perform one or more functions described as being performed by another set of components shown in FIG. 14.

FIG. 15 is a diagram of an example apparatus 1500, in accordance with the present disclosure.

The apparatus 1500 may be a core network node (e.g., an SMF), or a core network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 446. The communication manager 446 may include an MBS component 1508, among other examples.

In some aspects, the apparatus 1500 may be configured to perform one or more operations described herein in connection with FIGS. 6A and 6B. Additionally, or alternatively, the apparatus 1500 may be configured to perform one or more processes described herein, such as process 1100 of FIG. 11. In some aspects, the apparatus 1500 and/or one or more components shown in FIG. 15 may include one or more components of the core network node described in connection with FIG. 5. Additionally, or alternatively, one or more components shown in FIG. 15 may be implemented within one or more components described in connection with FIG. 5. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the core network node described in connection with FIG. 5.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the core network node described in connection with FIG. 5. In some aspects, the transmission component 1504 may be co-located with the reception component 1502 in a transceiver.

The reception component 1502 may receive an indication to release an MBS session of a UE, the indication including at least one of an MBS session status indication associated with the MBS session, the MBS session status indication indicating that the MBS session is inactive, or an indication that the UE has been removed from the MBS session. The MBS component 1508 may release the MBS session based at least in part on the indication to release the MBS session. The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components.

Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by an apparatus of a UE, comprising: leaving an MBS session without leaving a PDU session associated with the MBS session; and transmitting a signaling message after leaving the MBS session, the signaling message including an IE comprising an MBS session status indication associated with the MBS session.
Aspect 2: The method of Aspect 1, wherein the IE is an MBS session status update IE.
Aspect 3: The method of any of Aspects 1-2, wherein the UE is operating in a radio resource control inactive mode at a time of leaving the MBS session and the signaling message is an initial non-access stratum message, and the method further comprises resuming a signaling connection prior to transmitting the signaling message.
Aspect 4: The method of any of Aspects 1-2, wherein the UE is operating in an idle mode at a time of leaving the MBS session and the signaling message is an initial non-access stratum message, and the method further comprises establishing a signaling connection prior to transmitting the signaling message.
Aspect 5: The method of any of Aspects 1-4, wherein the signaling message is an initial NAS message, the initial NAS message being a registration update request message or a service request message.
Aspect 6: The method of any of Aspects 1-2, wherein the UE is operating in a connected mode and the signaling message is an uplink NAS message.
Aspect 7: The method of Aspect 6, wherein the uplink NAS message is an initial NAS message or an uplink NAS transport message.
Aspect 8: The method of any of Aspects 1-7, wherein the IE includes an MBS session identifier associated with the MBS session of the UE.
Aspect 9: The method of Aspect 8, wherein the MBS session identifier includes at least one of an MBS session identity or a temporary mobile group identifier.
Aspect 10: The method of any of Aspects 1-9, wherein the MBS session status indication is a one-bit indication, a two-bit binary value, or a three-bit binary value.
Aspect 11: The method of any of Aspects 1-10, wherein the IE includes multiple MBS session identifiers associated with multiple MBS sessions of the UE, and information indicating a status of each MBS session of the multiple MBS sessions of the UE.
Aspect 12: A method of wireless communication performed by an apparatus of a UE, comprising: leaving an MBS session without leaving a PDU session associated with the MBS session; and transmitting, for reception by a RAN node and based on leaving the MBS session, a signaling message including an indication that the UE has left the MBS session.
Aspect 13: The method of Aspect 11, wherein the UE is operating in a radio resource control inactive mode at a time at which the signaling message is transmitted.
Aspect 14: The method of any of Aspects 11-12, wherein the UE is operating in an idle mode at time at which the signaling message is transmitted.
Aspect 15: The method of any of Aspects 11-13, wherein the indication that the UE has left the MBS session includes an MBS session identifier associated with the MBS session.
Aspect 16: The method of Aspect 14, wherein the MBS session identifier includes at least one of an MBS session identity or a temporary mobile group identifier.
Aspect 17: A method performed by an apparatus of a core network node, comprising: receiving a NAS message including an MBS session status IE, wherein the MBS session status information IE includes an MBS session identifier corresponding to an MBS session of a UE and an MBS session status indication indicating a status of the MBS session; identifying a session management function (SMF) node based at least in part on an MBS context associated with the UE and the MBS session identifier; and forwarding the MBS session status indication to the SMF node.
Aspect 18: The method of Aspect 16, wherein the NAS message is an initial NAS message, the initial NAS message being a registration update request message or a service request message.
Aspect 19: The method of any of Aspects 16-17, wherein the NAS message is an uplink NAS transport message.
Aspect 20: The method of any of Aspects 16-18, wherein the MBS session identifier includes at least one of an MBS session identity or a temporary mobile group identifier.
Aspect 21: The method of any of Aspects 17-20, wherein the MBS session status update IE includes multiple MBS session identifiers associated with multiple MBS sessions of the UE, and information indicating a status of each MBS session of the multiple MBS sessions of the UE.
Aspect 22: A method performed by an apparatus of a RAN node, comprising: receiving a signaling message including an indication that a UE has left an MBS session; and removing the UE from the MBS session based at least in part on the indication that the UE has left the MBS session.
Aspect 23: The method of Aspect 20, wherein removing the UE from the MBS session comprises removing radio resources associated with the UE from a set of radio resources allocated to the MBS session.
Aspect 24: The method of any of Aspects 20-21, further comprising transmitting an indication that the UE has been removed from the MBS session to a core network node.
Aspect 25: The method of any of Aspects 20-22, wherein the indication that the UE has left the MBS session includes an MBS session identifier associated with the MBS session.
Aspect 26: A method performed by an apparatus of a core network node, comprising: receiving an indication to release an MBS session of a UE, the indication including at least one of: an MBS session status indication associated with the MBS session, the MBS session status indication indicating that the MBS session is inactive, or an indication that the UE has been removed from the MBS session; and releasing the MBS session based at least in part on the indication to release the MBS session.
Aspect 27: The method of Aspect 24, wherein releasing the MBS session comprises removing the MBS session from a PDU session context associated with the MBS session and a UE context associated with the UE.
Aspect 28: An apparatus for wireless communication at a device, comprising a processor; memory coupled with the processor; and instructions stored in the memory and executable by the processor to cause the apparatus to perform the method of one or more of Aspects 1-11.
Aspect 29: A device for wireless communication, comprising a memory and one or more processors coupled to the memory, the one or more processors configured to perform the method of one or more of Aspects 1-11.
Aspect 30: An apparatus for wireless communication, comprising at least one means for performing the method of one or more of Aspects 1-11.
Aspect 31: A non-transitory computer-readable medium storing code for wireless communication, the code comprising instructions executable by a processor to perform the method of one or more of Aspects 1-11.
Aspect 32: A non-transitory computer-readable medium storing a set of instructions for wireless communication, the set of instructions comprising one or more instructions that, when executed by one or more processors of a device, cause the device to perform the method of one or more of Aspects 1-11.
Aspect 33: An apparatus for wireless communication at a device, comprising a processor; memory coupled with the processor; and instructions stored in the memory and executable by the processor to cause the apparatus to perform the method of one or more of Aspects 12-16.
Aspect 34: A device for wireless communication, comprising a memory and one or more processors coupled to the memory, the one or more processors configured to perform the method of one or more of Aspects 12-16.
Aspect 35: An apparatus for wireless communication, comprising at least one means for performing the method of one or more of Aspects 12-16.
Aspect 36: A non-transitory computer-readable medium storing code for wireless communication, the code comprising instructions executable by a processor to perform the method of one or more of Aspects 12-16.
Aspect 37: A non-transitory computer-readable medium storing a set of instructions for wireless communication, the set of instructions comprising one or more instructions that, when executed by one or more processors of a device, cause the device to perform the method of one or more of Aspects 12-16.
Aspect 38: An apparatus at a device, comprising a processor; memory coupled with the processor, and instructions stored in the memory and executable by the processor to cause the apparatus to perform the method of one or more of Aspects 17-21.
Aspect 39: A device, comprising a memory and one or more processors coupled to the memory, the one or more processors configured to perform the method of one or more of Aspects 17-21.
Aspect 40: An apparatus, comprising at least one means for performing the method of one or more of Aspects 17-21.
Aspect 41: A non-transitory computer-readable medium storing code, the code comprising instructions executable by a processor to perform the method of one or more of Aspects 17-21.
Aspect 42: A non-transitory computer-readable medium storing a set of instructions, the set of instructions comprising one or more instructions that, when executed by one or more processors of a device, cause the device to perform the method of one or more of Aspects 17-21.
Aspect 43: An apparatus for wireless communication at a device, comprising a processor; memory coupled with the processor; and instructions stored in the memory and executable by the processor to cause the apparatus to perform the method of one or more of Aspects 22-25.
Aspect 44: A device for wireless communication, comprising a memory and one or more processors coupled to the memory, the one or more processors configured to perform the method of one or more of Aspects 22-25.
Aspect 45: An apparatus for wireless communication, comprising at least one means for performing the method of one or more of Aspects 22-25.
Aspect 46: A non-transitory computer-readable medium storing code for wireless communication, the code comprising instructions executable by a processor to perform the method of one or more of Aspects 22-25.
Aspect 47: A non-transitory computer-readable medium storing a set of instructions for wireless communication, the set of instructions comprising one or more instructions that, when executed by one or more processors of a device, cause the device to perform the method of one or more of Aspects 22-25.
Aspect 48: An apparatus at a device, comprising a processor; memory coupled with the processor; and instructions stored in the memory and executable by the processor to cause the apparatus to perform the method of one or more of Aspects 26-27.
Aspect 49: A device, comprising a memory and one or more processors coupled to the memory, the one or more processors configured to perform the method of one or more of Aspects 26-27.
Aspect 50: An apparatus, comprising at least one means for performing the method of one or more of Aspects 26-27.
Aspect 51: A non-transitory computer-readable medium storing code, the code comprising instructions executable by a processor to perform the method of one or more of Aspects 26-27.
Aspect 52: A non-transitory computer-readable medium storing a set of instructions, the set of instructions comprising one or more instructions that, when executed by one or more processors of a device, cause the device to perform the method of one or more of Aspects 26-27.

The foregoing disclosure provides illustration and description but is not intended to be exhaustive or to limit the aspects to the precise forms disclosed. Modifications and variations may be made in light of the above disclosure or may be acquired from practice of the aspects. Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects. As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects.

Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a +b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
leave a multicast broadcast services (MBS) session without leaving a packet data unit (PDU) session associated with the MBS session; and
transmit a signaling message after leaving the MBS session, the signaling message including an information element (IE) comprising an MBS session status indication associated with the MBS session.

2. The UE of claim 1, wherein the IE is an MBS session status update IE.

3. The UE of claim 1, wherein the UE is operating in a radio resource control inactive mode at a time of leaving the MBS session and the signaling message is an initial non-access stratum message, and the one or more processors are further configured to resume a signaling connection prior to transmitting the signaling message.

4. The UE of claim 1, wherein the UE is operating in an idle mode at a time of leaving the MBS session and the signaling message is an initial non-access stratum message, and the one or more processors are further configured to establish a signaling connection prior to transmitting the signaling message.

5. The UE of claim 1, wherein the signaling message is an initial non-access stratum (NAS) message, the initial NAS message being a registration update request message or a service request message.

6. The UE of claim 1, wherein the UE is operating in a connected mode and the signaling message is an uplink non-access stratum (NAS) message.

7. The UE of claim 6, wherein the uplink NAS message is an initial NAS message or an uplink NAS transport message.

8. The UE of claim 1, wherein the IE includes an MBS session identifier associated with the MBS session of the UE.

9. The UE of claim 8, wherein the MBS session identifier includes at least one of an MBS session identity or a temporary mobile group identifier.

10. The UE of claim 1, wherein the MBS session status indication is one of a one-bit indication, a two-bit binary value, or a three-bit binary value.

11. The UE of claim 1, wherein the IE includes multiple MBS session identifiers associated with multiple MBS sessions of the UE, and information indicating a status of each MBS session of the multiple MBS sessions of the UE.

12. A user equipment (UE) for wireless communication, comprising:
a memory; and
one or more processors, coupled to the memory, configured to:
leave a multicast broadcast services (MBS) session without leaving a packet data unit (PDU) session associated with the MBS session; and
transmit, for reception by a radio access network (RAN) node and based on leaving the MBS session, a signaling message including an indication that the UE has left the MBS session.

13. The UE of claim 12, wherein the UE is operating in a radio resource control inactive mode at a time at which the signaling message is transmitted.

14. The UE of claim 12, wherein the UE is operating in an idle mode at time at which the signaling message is transmitted.

15. The UE of claim 12, wherein the indication that the UE has left the MBS session includes an MBS session identifier associated with the MBS session.

16. The UE of claim 15, wherein the MBS session identifier includes at least one of an MBS session identity or a temporary mobile group identifier.

17. A core network node, comprising:
a memory; and
one or more processors, coupled to the memory, configured to:
receive a non-access stratum (NAS) message including a multicast broadcast services (MBS) session status information element (IE),
wherein the MBS session status information IE includes an MBS session identifier corresponding to an MBS session of a user equipment (UE) and an MBS session status indication indicating a status of the MBS session;
identify a session management function (SMF) node based at least in part on an MBS context associated with the UE and the MBS session identifier; and
forward the MBS session status indication to the SMF node.

18. The core network node of claim 17, wherein the NAS message is an initial NAS message, the initial NAS message being a registration update request message or a service request message.

19. The core network node of claim 17, wherein the NAS message is an uplink NAS transport message.

20. (canceled)

21. The core network node of claim 17, wherein the MB session status IE includes multiple MBS session identifiers associated with multiple MBS sessions of the UE, and information indicating a status of each MBS session of the multiple MBS sessions of the UE.

22-26. (canceled)
